(19) United States
(12) Patent Application Publication
(10) Pub. No.: US 2026/0062359 A1
(43) Pub. Date: Mar. 5, 2026

(54) METHOD OF AMENDING SOIL USING AN AMINE-FUNCTIONALIZED NATURAL CLAY

(71) Applicant: KING FAHD UNIVERSITY OF PETROLEUM AND MINERALS, Dhahran (SA)

(72) Inventors: Shahid ALI, Dhahran (SA); Faizah ALTAF, Dhahran (SA); Salem Awaid AL-SAADI, Dhahran (SA); Muhammad MANSHA, Dhahran (SA); Mahmoud M. ABDELNABY, Dhahran (SA); Safyan Akram KHAN, Dhahran (SA)

(73) Assignee: KING FAHD UNIVERSITY OF PETROLEUM AND MINERALS, Dhahran (SA)

(21) Appl. No.: 18/825,884

(22) Filed: Sep. 5, 2024

(51) Int. Cl. C05C 11/00; C05G 5/10; C05G 5/40

(52) U.S. Cl. CPC C05C 11/00; C05G 5/10; C05G 5/40

(57) ABSTRACT

A method of soil amendment includes treating montmorillonite (MMT) clay with an inorganic acid to form a treated clay with greater surface area and porosity than the MMT. The method further includes mixing tetraethylenepentamine (TEPA) with the treated clay to form a soil amendment. The soil amendment includes TEPA in an amount of 10 to 50 wt. % based on the weight of the soil amendment. The method further includes mixing the soil amendment with the soil to form a plant growth substrate. The plant growth substrate is capable of improving the plant growth rate in comparison to the soil without soil amendment. The soil with the soil amendment has a plant growth rate greater than the plant growth rate of the soil in the absence of the soil amendment.

### BACKGROUND

### Technical Field

The present disclosure is directed toward a method for amending soil to improve soil fertility using an amine-functionalized natural clay.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Elevated levels of CO₂ in the atmosphere lead to an increase in global temperature, contributing to the phenomenon known as global warming. Global warming poses a significant threat to coastal communities and low-lying regions, increasing the risk of floods and displacement of populations. To reduce the adverse effects of climate change and mitigate CO₂ emissions, there is a need for a method to lower CO₂ emissions already present in the atmosphere. Advanced adsorbent materials represent a promising solution to satisfy this need. These advanced adsorbent materials may be utilized to adsorb CO₂ emissions from the atmosphere. These advanced adsorbent materials may be designed to have a high affinity for CO₂ molecules, allowing them to selectively capture CO₂ from mixed gas streams. This selectivity ensures efficient CO₂ capture without unwanted side effects, such as decreasing the amount of oxygen and nitrogen in the atmosphere. The properties of advanced adsorbent materials may be fine-tuned to capture CO₂ under different conditions and from various sources. The captured CO₂ can be converted into beneficial products such as light olefins, dimethyl carbonate, methanol, formic acid, syngas, and methane, through carbon utilization processes. These advanced adsorbent materials may also aid in providing a concentrated and purified source of CO₂ for these carbon utilization processes, potentially closing the carbon loop.

In recent years, natural clays such as montmorillonite, bentonite, saponite, sepiolite, and palygorskite, have been studied for their potential use in CO₂ fixation and capture. Among different types of natural clays, montmorillonite (MMT) may be preferable for CO₂ fixation due to its large surface area having ample sites for CO₂ molecules to adhere. Modifying natural clays may further enhance their adsorption capabilities, making them suitable for capturing CO₂ selectively and efficiently. MMT may also be used for soil improvement. When added to soils, MMT may enhance soil structure, water uptake, and nutrient availability. This can indirectly contribute to CO₂ fixation by promoting plant growth and organic matter accumulation in the soil. MMT may be further beneficial in arid regions, where enhancing soil fertility, water retention, and crop yields is important to agriculture. Previous studies have synthesized kaolinite/n-hexylamine complex, to obtain a CO₂ adsorption capacity of 17.0 (+0.4) mL/g. Others have prepared an MMT-based adsorbent having an adsorption capacity of 100.67 mg g⁻¹. Similarly, some studies have developed a composite of MMT clay and reduced graphene oxide for CO₂ adsorption, exhibiting a CO₂ adsorption of 0.49 mmol g⁻¹ (˜12.0 cm³ g⁻¹).

Each of the previous studies suffers from certain drawbacks, such as poor selectivity and high costs, which hinder their adoption. Accordingly, one object of the present disclosure is to develop a modified MMT with improved selectivity to CO₂ and a method of utilizing the modified MMT to adsorb CO₂ emissions from the atmosphere to a soil to amend the soil and increase soil fertility.

### SUMMARY

In an exemplary embodiment, a method of soil amendment is described. The method comprises the treatment of a montmorillonite (MMT) clay with an inorganic acid to form a treated clay having greater surface area and porosity than the MMT. The method further comprises mixing tetraethylenepentamine (TEPA) with the treated clay to form a soil amendment comprising the TEPA in an amount of 10 to 50 wt. % based on the weight of the soil amendment, mixing the soil amendment with the soil to form a plant growth substrate; wherein the plant growth substrate is capable of improved plant growth rate in comparison to the soil without the soil amendment, and wherein the soil with the soil amendment has a plant growth rate that is at least 5% greater than the plant growth rate of the soil in the absence of the soil amendment.

In some embodiments, the soil is in the form of a fine powder having a particle size of less than 0.6 mm for amendment.

In some embodiments, the inorganic acid is selected from the group consisting of hydrochloric acid (HCl), sulfuric acid (H₂SO₄), perchloric acid (HCIO₄), boric acid (H₃BO₃), and nitric acid (HNO₃).

In some embodiments, the inorganic acid is HCl.

In some embodiments, the soil amendment has a rough surface with a plurality of small protrusions.

In some embodiments, the soil amendment has an average hydrodynamic size of 0.15 to 2.5 micrometers (μm).

In some embodiments, the soil amendment is amorphous.

In some embodiments, the plant growth substrate has a mass ratio of sand to soil amendment of 1:1 to 10:1.

In some embodiments, the soil is at least one selected from the group consisting of pure sand, sandy soil, clay soil, silt soil, peat soil, and loam soil.

In some embodiments, the soil is sandy soil.

In some embodiments, the plant growth substrate has a pH of 3 to 8.

In some embodiments, the soil amendment has an average surface area of 10 to 400 m²/g.

In some embodiments, the soil amendment has an average pore diameter of no more than 8 cm³/g.

In some embodiments, the soil amendment has an average pore volume of 0.01 to 0.6 cm³/g.

In some embodiments, the TEPA is present in an amount of 30 wt. %.

In some embodiments, the plant growth substrate is in the form of a micropellet having an average diameter of 0.1 to 3 mm.

In some embodiments, the plant growth substrate further comprises at least one selected from the group consisting of nitrogen (N), potassium (K), phosphorus (P), calcium (Ca), magnesium (Mg), sulfur(S), boron (B), copper (Cu), iron (Fe), manganese (Mg), zinc (Zn), chlorine (Cl), and cobalt (Co); and a humate comprising at least one selected from the group consisting of humic acid, fulvic acid, humin, and hymatomelanic acid.

In some embodiments, the soil amendment has a CO₂ adsorption capacity of 70 to 130 cm³/g.

In some embodiments, the soil amendment has a CO₂ adsorption capacity of 115.3 cm³/g.

In some embodiments, the plant growth substrate has a ratio of sand to soil amendment of 9:1.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method of amending a soil, according to certain embodiments.

FIG. 1B is a schematic diagram depicting the use of adsorbed CO₂ to enhance soil fertility, according to certain embodiments.

FIG. 2 is a pictorial image depicting a synthetic layout for tetraethylenepentamine-modified montmorillonite (TEPA-MMT), according to certain embodiments.

FIG. 3A is an image depicting X-ray diffraction (XRD) patterns for montmorillonite (MMT) and acid-activated MMT (AA-MMT) clay samples, according to certain embodiments.

FIG. 3B is an image depicting XRD patterns for TEPA10, TEPA30, and TEPA50 clay samples, according to certain embodiments.

FIG. 4A is a Fourier-transform infrared spectroscopy (FTIR) spectra of the MMT and AA-MMT clay samples, according to certain embodiments.

FIG. 4B is a FTIR spectra of the TEPA10, TEPA30, and TEPA50 clay samples, according to certain embodiments.

FIG. 5A is scanning electron microscope (SEM) image of the AA-MMT clay sample, according to certain embodiments.

FIG. 5B is a SEM image of the TEPA10 clay sample, according to certain embodiments.

FIG. 5C is a SEM image of the TEPA30 clay sample, according to certain embodiments.

FIG. 5D is a SEM image of the TEPA50 clay sample, according to certain embodiments.

FIG. 6A is a transmission electron microscopy (TEM) image of the AA-MMT clay sample, according to certain embodiments.

FIG. 6B is a TEM image of the TEPA10 clay sample, according to certain embodiments.

FIG. 6C is a TEM image of the TEPA30 clay sample, according to certain embodiments.

FIG. 6D is a TEM image of the TEPA50 clay sample, according to certain embodiments.

FIG. 7 shows dynamic light scattering (DLS) size distribution for the AA-MMT, TEPA10, TEPA30, and TEPA50 clay samples, according to certain embodiments.

FIG. 8 shows CO₂ adsorption-desorption curves for AA-MMT, TEPA10, TEPA30, and TEPA50 clay samples, according to certain embodiments.

FIG. 9A shows a hydroponic system under artificial sunlight, according to certain embodiments.

FIG. 9B shows a plantation of mint and coriander seeds in conical pots, according to certain embodiments.

FIG. 9C shows plant growth in modified clay (TEPA30) after four weeks, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed at mitigating CO₂ from the environment by sequestering it in soil and utilizing it as a fertilizer for plants, leveraging cost-effective clay minerals such as montmorillonite (MMT). In one embodiment, pure MMT clay is acidified with an inorganic acid to enhance its surface area and porosity. In one embodiment, the acidified clay is modified with tetraethylenepentamine (TEPA) to obtain an effective adsorbent of CO₂, thereby augmenting soil fertility.

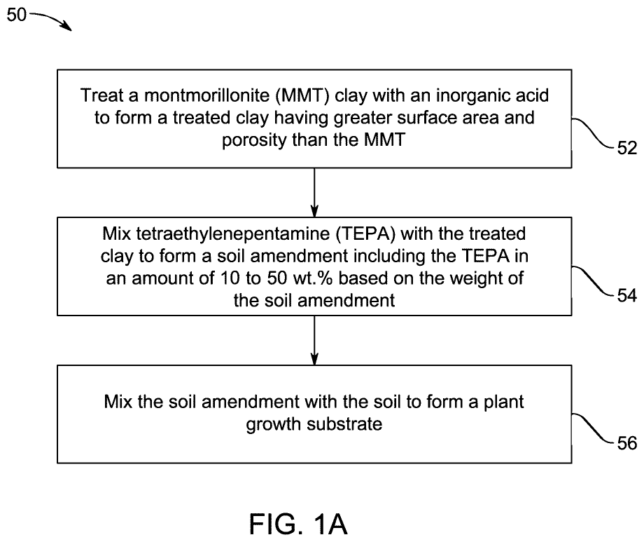

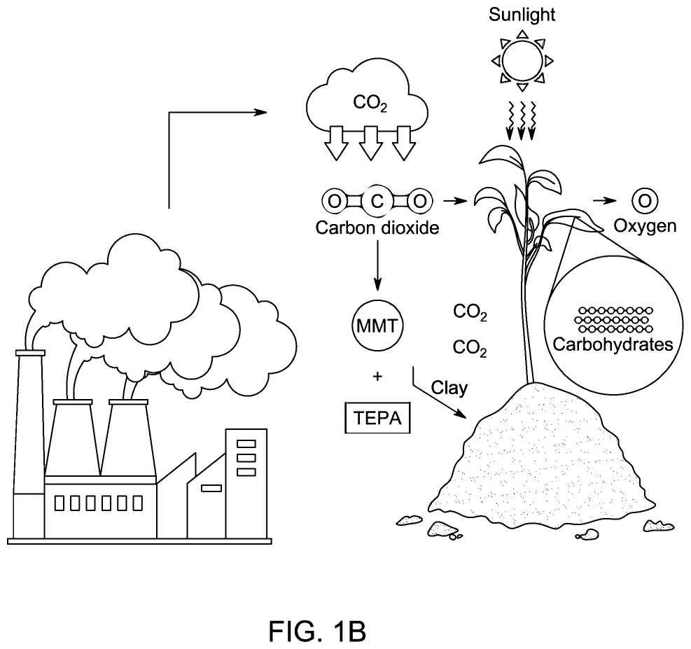

Referring to FIG. 1A, a method 50 of amending soil is described. As used herein, the term ‘soil’ refers to the heterogeneous, natural substrate consisting of mineral particles of varying sizes interspersed with organic matter derived from decomposed plant and animal residues. Soil is a foundational medium for vegetation growth, fostering microbial communities and facilitating essential biogeochemical processes. Its composition and properties are pivotal in agricultural, environmental, and industrial applications, encompassing nutrient availability, water retention, and structural stability. The soil is at least one selected from the group consisting of pure sand, sandy soil, clay soil, silt soil, peat soil, and loam soil. In some embodiments, the soil may include, but is not limited to, chalk soil, sandy loam soil, clay loam soil, silty clay soil, chernozem soil, laterite soil, podzol soil, and alluvial soil. In a preferred embodiment, the soil is sandy soil. The order in which the method 50 is described is not intended to be construed as a limitation, and any number of the described method 50 steps may be combined in any order to implement the method 50. Additionally, individual steps may be removed or skipped from method 50 without departing from the spirit and scope of the present disclosure.

In one embodiment, at step 52, the method 50 comprises treating montmorillonite (MMT) clay with an inorganic acid to form a treated clay having greater surface area and porosity than the MMT. As used herein, the term ‘MMT clay’, a member of the smectite group, is distinguished by its pronounced swelling characteristics and high cation exchange capacity. Including layered aluminum and magnesium silicates arranged in a lattice structure, MMT clay may adsorb and retain water molecules within its interlayer spaces. Its versatility is attributed to its ability to enhance soil quality by improving structure, facilitating water retention, and serving as an effective adsorbent for toxins and heavy metals. The MMT clay may be N-type and/or Ca-type. In the N-type, the exchangeable ion is sodium, and in the Ca-type, the exchangeable ion is calcium. In an embodiment, the MMT clay is both N-type and Ca-type MMT. In another embodiment, the MMT clay is N-type MMT. In yet another embodiment, the MMT clay is Ca-type MMT.

In some embodiments, the MMT clay is purified before being treated with an inorganic acid. The purification may be done by dispersing it with water to obtain a mixture. In some embodiments, the MMT clay mixture is then stirred for 18 to 24 hours (h) and filtered using filter paper. In some embodiments, the MMT clay mixture is stirred for 19 to 24 h, preferably 20 to 24 h, preferably 21 to 24 h, preferably 22 to 24 h, preferably 23 to 24 h, most preferably 24 h. Any suitable known modes of filtration may also be used, such as gravity filtration, hot filtration, centrifugation, decanting, suction filtration, and pipette filtration. In some embodiments, after filtration, the MMT clay is dried, preferably in an oven, to a temperature of 75° C. to 125° C., preferably about 80° C. to 120° C., preferably about 85° C. to 115° C., preferably about 90° C. to 110° C., most preferably about 95° C. The MMT clay is dried for 18 to 36 h, preferably 20 to 34 h, preferably 22 to 32 h, preferably 24 to 30 h, preferably 24 to 28 h, preferably 24 to 26 h, most preferably 24 h. The dried MMT clay is further ground to reduce its particle size. The dried MMT clay is ground to achieve a particle size of less than 45 μm, preferably less than 40 μm, preferably less than 35 μm, preferably less than 30 μm, preferably less than 25 μm, preferably less than 20 μm, most preferably less than 15 μm. The MMT clay obtained is amorphous and may be in the form of powder, granules, or mixtures thereof. In a preferred embodiment, the MMT clay is in the form of a powder.

In some embodiments, the MMT clay is further acidified using an inorganic acid to increase its surface area and porosity. The acidification occurs by mixing and/or suspending the MMT clay in the inorganic acid to form a mixture. In some embodiments, the inorganic acid may be hydrochloric acid (HCl), sulfuric acid (H₂SO₄), perchloric acid (HClO₄), boric acid (H₃BO₃), and nitric acid (HNO₃), phosphoric acid (H₃PO₄), hydrofluoric acid (HF), hydrobromic acid (HBr), hydroiodic acid (HI), chloric acid (HClO₃), bromic acid (HBrO₃), iodic acid (HIO₃), selenic acid (H₂SeO₄), telluric acid (H₆O₆Te), chromic acid (H₂CrO₄), manganic acid (H₂MnO₄), periodic acid (HIO₄), arsenic acid (H₃AsO₄), phosphorous acid (H₃PO₃), hypophosphorous acid (H₃PO₂), hypochlorous acid (HCIO), chlorous acid (HCIO₂), hypobromous acid (HBrO), bromous acid (HBrO₂), hypoiodous acid (HIO), iodous acid (HIO₂), perbromic acid (HBrO₄), and carbonic acid (H₂CO₃). In another embodiment, the inorganic acid is selected from the group consisting of HCl, H₂SO₄, HClO₄, H₃BO₃, and HNO₃. In a preferred embodiment, the inorganic acid is HCl. In one embodiment, the concentration of the inorganic acid is about 1 M to 10 M, preferably 2 M to 9 M, preferably 2 M to 8 M, preferably 2 M to 7 M, preferably 2 M to 6 M, preferably 2 M to 5 M, preferably 2 M to 4 M, preferably 2 M to 3 M, most preferably 2 M. In some embodiments, the mixture is stirred for 10 hours to 20 hours, preferably 12 hours to 18 hours, preferably 14 hours to 16 hours, most preferably 15 hours. In one embodiment, the mixture is filtered and the obtained solid is then washed with a solvent to remove any unreacted acids. Any suitable filtration methods may be used, such as filtration with filter paper, gravity filtration, hot filtration, centrifugation, decanting, suction filtration, and pipette filtration. Any suitable solvent may be used in washing, such as water, ethanol, and acetone. In one embodiment, the mixture is filtered then washed with water to remove any unreacted acids. In one embodiment, after the mixture is filtered then washed, the mixture is oven dried at a temperature of 75° C. to 125° C., preferably 80 to 120° C., preferably 85 to 115° C., preferably 90 to 110° C., preferably 90 to 105° C., preferably 90 to 100° C., preferably 90 to 95° C., most preferably about 90° C. The mixture is oven dried for 5 to 15 h, preferably 6 to 14 h, preferably 7 to 13 h, most preferably 8 to 12 h to obtain the treated clay. The treated clay further comprises a minor amount of silica, preferably amorphous silica. The average hydrodynamic size of the treated clay is in the range of 0.3 to 0.4 μm, preferably 0.31 to 0.39 μm, preferably 0.32 to 0.38 μm, preferably 0.33 to 0.37 μm, preferably 0.34 to 0.36 μm, most preferably 0.35 μm.

In one embodiment, at step 54, the method 50 comprises mixing TEPA with the treated clay to form a soil amendment. In some embodiments, TEPA may be dissolved in a solvent before mixing it with the treated clay. In one embodiment, the solvent may be any suitable alcohol, such as ethanol, methanol, butanol, and isopropanol. In another embodiment, the solvent is ethanol. In some embodiments, the v/v ratio of TEPA to the solvent, preferably ethanol, is in the range of 1:5 to 1:15, preferably 1:6 to 1:14, preferably 1:7 to 1:13, preferably 1:8 to 1:12, preferably 1:9 to 1:11, most preferably 1:10. The TEPA was mixed with the treated clay and subjected to agitation for 1 h to 4 h, preferably 1.5 to 3.5 h, preferably 2 to 3 h, preferably 2.5 to 3 h, most preferably 3 h. In one embodiment agitation is performed by sonication, however other known modes of agitation may be utilized. In another embodiment, the TEPA is mixed with the treated clay via sonication to form the soil amendment. The agitation results in exfoliating the thin crystalline layers of the MMT clay. The exfoliated layer has an exposed surface that is easy to access and modify with TEPA. In some embodiments, the TEPA is present in an amount of 10 to 50 wt. %, preferably 12 to 48 wt. %, preferably 14 to 46 wt. %, preferably 16 to 44 wt. %, preferably 18 to 42 wt. %, preferably 20 to 40 wt. %, preferably 22 to 38 wt. %, preferably 24 to 36 wt. %, preferably 26 to 34 wt. %, preferably 28 to 32 wt. %, most preferably 30 wt. %, based on the weight of the soil amendment. In some embodiments, TEPA may be substituted by polyethyleneimine (PEI), ethylene diamine (EDA), polyamidoamine (PAMAM) dendrimers, triethylenetetramine (TETA), and urea.

Morphological analysis shows that the soil amendment has a rough surface with several protrusions. In some embodiments, these protrusions have an average diameter of 0.5 μm or less, preferably, 0.02 to 0.4 μm, preferably 0.05 to 0.3 μm, most preferably 0.1 to 0.2 μm, and an average height of 0.3 μm or less, preferably, 0.02 to 0.2 μm, preferably 0.05 to 0.1 μm. In an embodiment, the rough surface of the soil amendment has at least 50 to 300 protrusions, preferably 55 to 295 protrusions, preferably 60 to 290 protrusions, preferably 65 to 285 protrusions, preferably 70 to 280 protrusions, preferably 75 to 275 protrusions, preferably 80 to 270 protrusions, preferably 85 to 265 protrusions, preferably 90 to 260 protrusions, preferably 95 to 255 protrusions, preferably 100 to 250 protrusions, preferably 105 to 250 protrusions, preferably 110 to 250 protrusions, preferably 115 to 250 protrusions, preferably 120 to 250 protrusions, preferably 125 to 250 protrusions, preferably 130 to 250 protrusions, preferably 135 to 250 protrusions, preferably 140 to 250 protrusions, preferably 145 to 250 protrusions, most preferably 150 to 250 protrusions per particle. This is due to the interaction between the layers of MMT clay and TEPA, which results in a rough surface. In another embodiment, the soil amendment has an average hydrodynamic diameter of 0.15 to 2.5 μm, preferably 0.2 to 2 μm, preferably 0.25 to 1.5 μm, preferably 0.3 to 1 μm, most preferably 0.35 to 1 μm. In one embodiment, the soil amendment is amorphous and is in the form of a fine powder having a particle size of less than 0.6 mm, preferably less than 0.5 mm, preferably less than 0.4 mm, preferably less than 0.3 mm, most preferably less than 0.2 mm. In some embodiments, the soil amendment has an average surface area of 10 to 400 m²/g, preferably 15 to 395 m²/g, preferably 20 to 390 m²/g, preferably 25 to 385 m²/g, preferably 30 to 380 m²/g, preferably 35 to 375 m²/g, preferably 40 to 370 m²/g, preferably 45 to 365 m²/g, preferably 50 to 360 m²/g, preferably 50 to 355 m²/g, preferably 50 to 350 m²/g, preferably 50 to 345 m²/g, preferably 50 to 340 m²/g, preferably 50 to 335 m²/g, preferably 50 to 330 m²/g, preferably 50 to 325 m²/g, preferably 50 to 320 m²/g, preferably 50 to 315 m²/g, preferably 50 to 310 m²/g, preferably 50 to 305 m²/g, most preferably 50 to 300 m²/g. In another embodiment, the soil amendment has an average pore diameter of no more than 8 cm³/g, preferably no more than 7.5 cm³/g, preferably no more than 7 cm³/g, preferably no more than 6.5 cm³/g, most preferably no more than 6 cm³/g. In one embodiment, the soil amendment has an average pore volume of 0.01 to 0.6 cm³/g, preferably 0.02 to 0.55 cm³/g, preferably 0.03 to 0.5 cm³/g, preferably 0.04 to 0.45 cm³/g, preferably 0.05 to 0.4 cm³/g, preferably 0.06 to 0.4 cm³/g, preferably 0.07 to 0.4 cm³/g, preferably 0.08 to 0.4 cm³/g, preferably 0.09 to 0.4 cm³/g, most preferably 0.1 to 0.4 cm³/g. In one embodiment, the soil amendment has a CO₂ adsorption capacity of 70 to 130 cm³/g, preferably 75 to 125 cm³/g, preferably 80 to 120 cm³/g, preferably 85 to 120 cm³/g, preferably 90 to 120 cm³/g, preferably 95 to 120 cm³/g, preferably 110 to 120 cm³/g, preferably 115 to 120 cm³/g, most preferably about 115.3 cm³/g.

In one embodiment, at step 56, the method 50 comprises mixing the soil amendment with the soil to form a plant growth substrate. In one embodiment, the weight ratio of the soil to the soil amendment is in the range of 1:1 to 10:1, preferably 2:1 to 9:1, preferably 3:1 to 9:1, preferably 4:1 to 9:1, preferably 5:1 to 9:1, preferably 6:1 to 9:1, preferably 7:1 to 9:1, preferably 8:1 to 9:1, most preferably 9:1. In one embodiment, the pH of the plant growth substrate is adjusted between 3 to 8, preferably between 4 to 7. In some embodiments, the plant growth substrate, including the soil amendment and soil is mixed with water to form a wet mixture. In other embodiments, the wet mixture may be extruded with an extruder and cut to form pellets. In an embodiment, the plant growth substrate is in the form of a micropellet, having an average diameter of 0.1 to 3 mm, preferably 0.2 to 2.9 mm, preferably 0.3 to 2.8 mm, preferably 0.4 to 2.7 mm, preferably 0.5 to 2.6 m, preferably 0.5 to 2.5 mm, preferably 0.5 to 2.4 mm, preferably 0.5 to 2.3 mm, preferably 0.5 to 2.2 mm, preferably 0.5 to 2.1 mm, most preferably 0.5 to 2 mm.

In some embodiments, the plant growth substrate further comprises at least one of nitrogen (N), potassium (K), phosphorus (P), calcium (Ca), magnesium (Mg), sulfur(S), boron (B), copper (Cu), iron (Fe), manganese (Mg), zinc (Zn), chlorine (Cl), and cobalt (Co). In some embodiments, the plant growth substrate further comprises compost, manure, lime, and molybdenum (Mo). In another embodiment, the plant growth substrate further comprises a humate selected from humic acid, fulvic acid, humin, and hymatomelanic acid. A humate is an organic compound that is derived from the decomposition of organic matter, such as plant and animal residues in soils. Humates are beneficial in soil fertility and health by improving soil structure, enhancing nutrient availability, promoting microbial activity, and facilitating water retention. They are used in agriculture and horticulture as soil conditioners and fertilizer additives to promote plant growth and increase crop yields. Humates are rich in humic substances, including humic acid, fulvic acid, humin, and hymatomelanic acid. Humic acid is a complex mixture of organic acids and other organic compounds that are part of the humic substances found in soil, peat, and natural waters. It is insoluble in acidic conditions but can form salts (humates) that are soluble in alkaline conditions. Humic acid is characterized by its high molecular weight and dark color. It contributes to soil fertility by improving nutrient retention, water holding capacity, and soil structure. It forms through the microbial degradation of plant and animal residues over long periods. Fulvic acid is a smaller molecular weight fraction of humic substances, soluble in both acidic and alkaline conditions. It is characterized by its yellow to yellow-brown color and high solubility in water. Fulvic acid aids in nutrient transport and absorption by plants, acting as a chelating agent that binds minerals and makes them more available for plant uptake. It also enhances soil structure, stimulates microbial activity, and promotes plant growth. Humin is the fraction of humic substances that is insoluble in acidic conditions and remains after extraction of humic and fulvic acids. It is dark brown to black in color and consists of highly polymerized and complex organic molecules. Humin is resistant to further microbial degradation and plays a role in soil aggregation, carbon sequestration, and long-term nutrient storage in soils. Hymatomelanic acid is a less common and less well-defined component of humic substances. It forms through the oxidative transformation of organic matter and contributes to the dark color of humus in soils. Its specific chemical structure and exact role in soil processes are still under study, but it is believed to play a role in soil fertility and organic matter stability.

The plant growth substrate is capable of improving plant growth rate in comparison to the soil without soil amendment. In a specific embodiment, the soil with the soil amendment has a plant growth rate that is at least 9% greater than the plant growth rate of the soil in the absence of the soil amendment, preferably 11% greater, preferably 13% greater, preferably 15% greater, preferably 18% greater, preferably 21% greater, preferably 23% greater, preferably 25% greater, preferably 28% greater, preferably 31% greater, preferably 33% greater, preferably 35% greater, preferably 38% greater, preferably 41% greater, preferably 43% greater, preferably 45% greater, preferably 48% greater, preferably 51% greater, preferably 53% greater, preferably 55% greater, most preferably 55.28% greater than the plant growth rate of the soil in the absence of the soil amendment. The enhancement of plant growth with the plant growth substrate may be associated with more amino functional groups/adsorption sites at the MMT surface, resulting in greater adsorption of CO₂; hence the improved soil fertility and better plant growth. FIG. 1B depicts a schematic diagram depicting the use of adsorbed CO₂ to enhance soil fertility.

### EXAMPLES

The following examples demonstrate a method of amending soil. The examples are provided solely for illustration and are not to be construed as limitations of the present disclosure, as many variations thereof are possible without departing from the spirit and scope of the present disclosure.

### Example 1: Materials

MMT clay powder and TEPA were purchased from Sigma-Aldrich. The activating agent hydrochloric acid (HCl, 37%) was purchased from Sigma, and absolute ethanol (C₂H₅OH, 99%) was acquired from Analar. Milli-Q ultrapure deionized (DI) water was used throughout the investigation. All the experiments were performed at room temperature (24° C.). For gas sorption experiments, ultra-high pure N₂ (99.99%) and CO₂ (99.99%) gases have been obtained from Linde, Dammam, Saudi Arabia.

### Example 2: Fabrication of Clay-Based Adsorbents

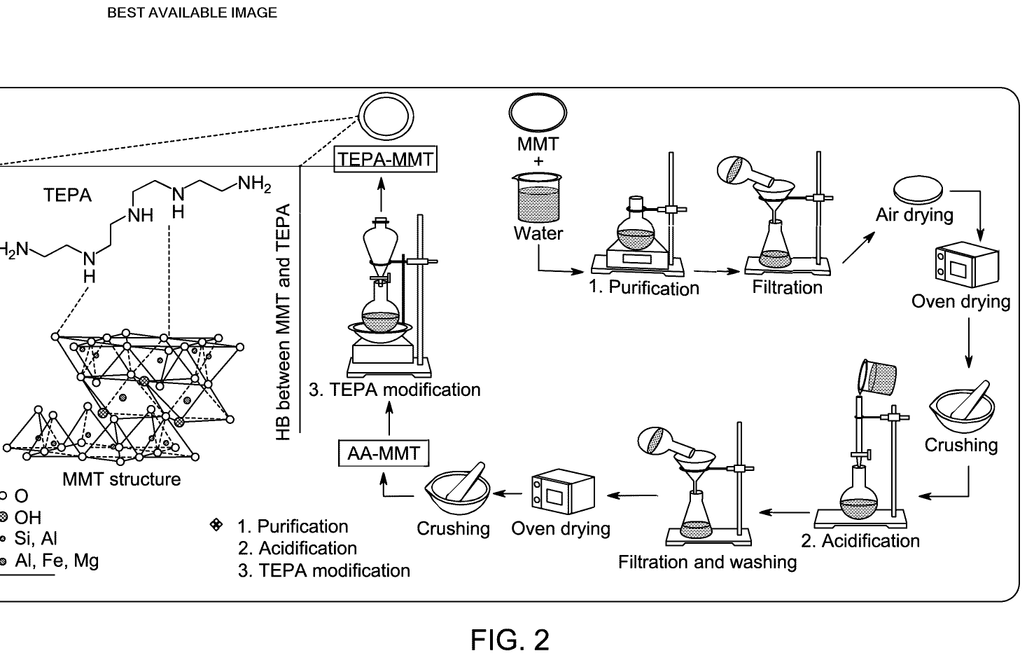

The fabrication process for clay-based adsorbents consisted of the following three steps. (1) Purification of MMT clay: 10 g of clay was placed into a round bottom flask containing 1000 mL of deionized (DI) water for complete dispersion. The system was vigorously stirred via a magnetic stirrer for 24 hours. The purified clay was filtered using Whatman filter paper to obtain a product. The product was first air-dried and then oven-dried at 95° C. for 24 h. The dried clay was ground in pastel mortar to make amorphous clay for further processing and labeled as MMT for further use. (2) Acidification of MMT clay: the purified MMT was acidified with hydrochloric acid (HCl) to increase its surface area and porosity. 10 g of the purified MMT was added to 300 mL of the hydrochloric acid (2 M) solution, and the mixture was stirred for 15 h. Then, the suspension was filtered, washed with DI water, and dried in an oven at 90° C. overnight. The sample was labeled ‘AA-MMT’ for further use. (3) MMT Modification using TEPA ligand: TEPA-modified MMT was prepared using a wet impregnation method. TEPA (2 mL) was dissolved into ethanol (20 mL) in a round bottom flask. The resultant solution was kept stirring for 30 minutes. Then, acid-activated MMT (AA-MMT) clay was added to the above ethanol solution, and the mixture was sonicated for 180 minutes. After that, the slurry was dried in an oven at 50° C. Finally, the dried product was crushed in pestle mortar to make fine powder and saved for further use. The schematic representation for the surface modification of TEPA-MMT clay is shown in FIG. 2. Various compositions of TEPA-modified MMT clay were prepared using 10, 30, and 50 wt. % of TEPA and labeled as TEPA10, TEPA30, and TEPA50, respectively.

### Example 3: Characterization Techniques

X-ray diffraction (XRD) analyses were performed with a Rigaku Smart lab X-ray diffraction system. The studies used Cu Kal source line (1.5406 Å) operating at 40 kV/40 mA, with 20 ranging from 5° to 70° with 0.020 steps. Various functionalities on the surface of clay adsorbent were characterized by Fourier transform infrared (FTIR) spectroscopy using a Nicolet/iS50 spectrometer in the frequency range of 4000-400 cm⁻¹. Scanning electron microscopy (SEM) images were captured by an FEI Quanta 450 microscope with a Schottky field emission gun at an accelerating voltage of 20 kV. Before SEM observation, the samples were coated with a thin carbon layer. A transmission electron microscope (JEM-2100F, JEOL) was used to observe the internal structure of synthesized clay materials. This investigation used a Cu-grid to support the clay material suspension (5.0 μL). The hydrodynamic size of functionalized clay materials was measured using the dynamic light scattering (DLS) technique via Zetasizer nano (ZEN3600, Malvern, UK). A gravimetric gas/vapor sorption (DVS) vacuum analyzer was used with a pure CO₂ (99.99%) cylinder for CO₂ adsorption/desorption studies.

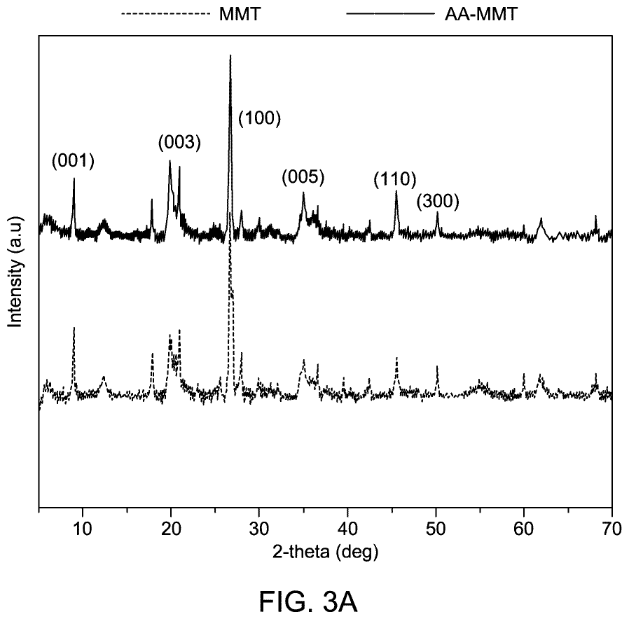

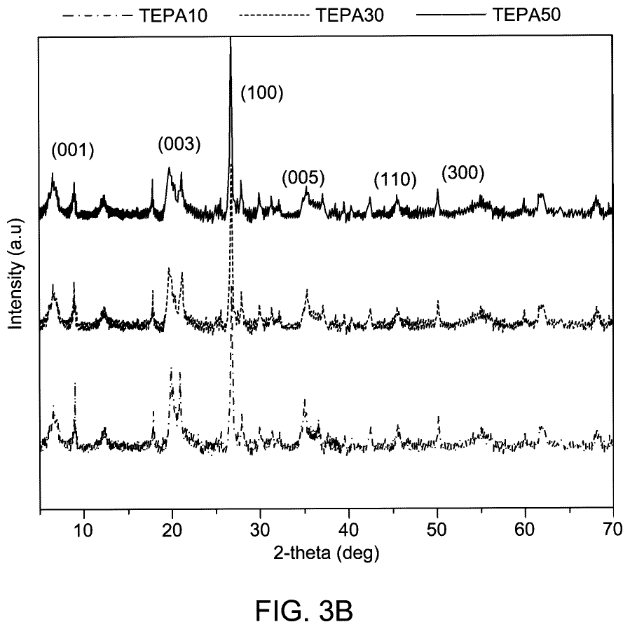

TEPA-modified MMT clay materials were characterized to verify their chemical composition, structure, TEPA-MMT linkage, surface morphology, and hydrodynamic size. For this purpose, various characterization techniques (XRD, FTIR, SEM, TEM, and DLS) were engaged to obtain these properties. XRD pattern can confirm the retention of clay structure after TEPA modification. FIGS. 3A-3B show the XRD pattern of (a) MMT, AA-MMT, (b) TEPA10, TEPA30, and TEPA50 clay samples. From FIG. 3(A), the six characteristic peaks appeared at 7.4°, 20.1°, 28.6°, 35.4°, 45.0°, and 54.5°, which correspond to (001), (003), (100), (005), (110), and (300) crystal planes of montmorillonite (MMT), respectively. These diffraction planes can provide information about the arrangement and distribution of atoms in the crystal and, therefore, can be used to determine the properties of MMT clay. The comparison of XRD spectra of MMT and AA-MMT clays indicates that the crystallinity of MMT is slightly decreased after acid modification. For TEPA-modified MMT clay, no further peak appeared that corresponds to TEPA functionality (FIG. 3B). However, there is a slight decrease in the peak intensities by increasing the concentration of modifying agent (TEPA), confirming the induction of TEPA ligand within the MMT clay structure. The addition of TEPA results in the exfoliation of clay galleries, which increases the surface area and amorphous phase, thus reducing the crystalline phase and lowering peak intensities.

Pure MMT clay consists of large numbers of thin crystalline layers, superimposing each other and presenting small inter-layer distances with limited access for introducing foreign moieties. The superimposed framework gets damaged during the exfoliation. The exfoliated layer has an exposed surface that is easy to access and modify. The exfoliated MMT with a large surface area is more suitable for CO₂ adsorption. Among all samples, TEPA30 and TEPA50 showed more exfoliated structure, which may result in better CO₂ adsorption capacity.

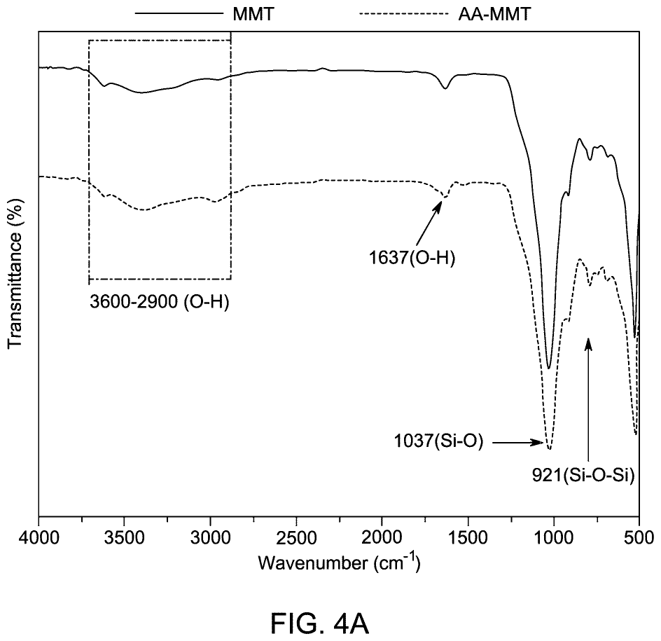

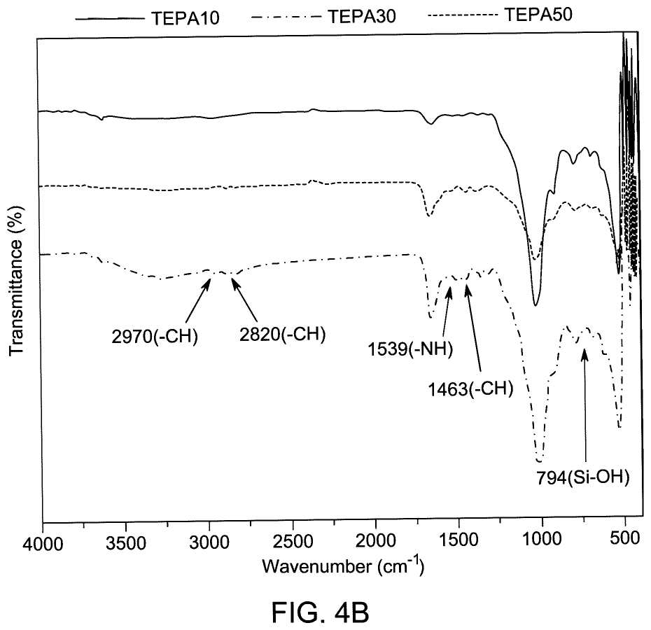

FTIR spectra can confirm TEPA (amine) functionality at the surface of MMT clay. FIGS. 4A-4B display the FTIR spectra of (FIG. 4A) MMT, AA-MMT, and (FIG. 4B) TEPA10, TEPA30, and TEPA50 clay samples. From FIG. 4A, the band appearing at 1637 cm⁻¹ is associated with stretching vibrations of water molecules bonded to Mg²⁺ cations for pure MMT. These water molecules are present at the edges of the octahedral layer. However, this band becomes broader after acidification due to increased surface area. For MMT clay, the band detected at 915 cm⁻¹ is due to the stretching vibrations of Si—O—Si bonds and is sensitive to acid activation. After acidification, the band at 910 cm⁻¹ shifted to 921 cm⁻¹, possibly due to some amorphous silica formation. Upon induction of TEPA ligand in AA-MMT clay galleries, some new bands appeared in the FTIR spectrum of modified MMT clay that confirmed the presence of TEPA functionality (FIG. 4B). The bands that appeared at 1539 and 3269 cm⁻¹ are related to —NH bending and stretching vibrations, respectively. In addition, the bands at 1463, 2860, and 2970 cm⁻¹ are attributed to —CH bending and stretching vibrations of TEPA moiety. The comparison of FTIR spectra of TEPA10, TEPA30, and TEPA50 indicates that the intensity of —NH bending and stretching vibrations increased by increasing the concentration of TEPA functionality from 10-50 wt. %. This confirms the presence of more amine functional groups at the surface of MMT, increasing the interaction and exfoliation of clay galleries.

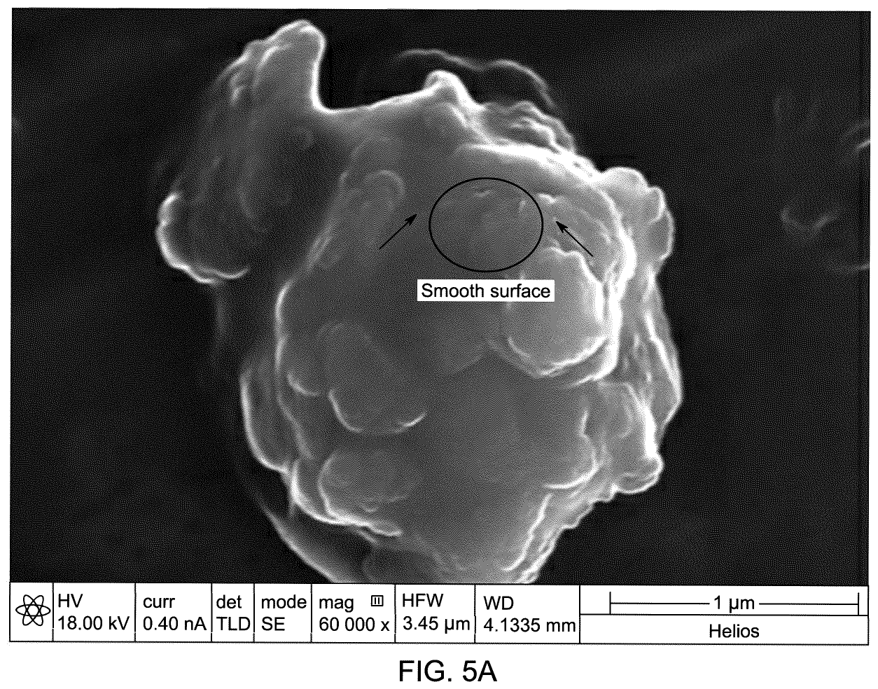

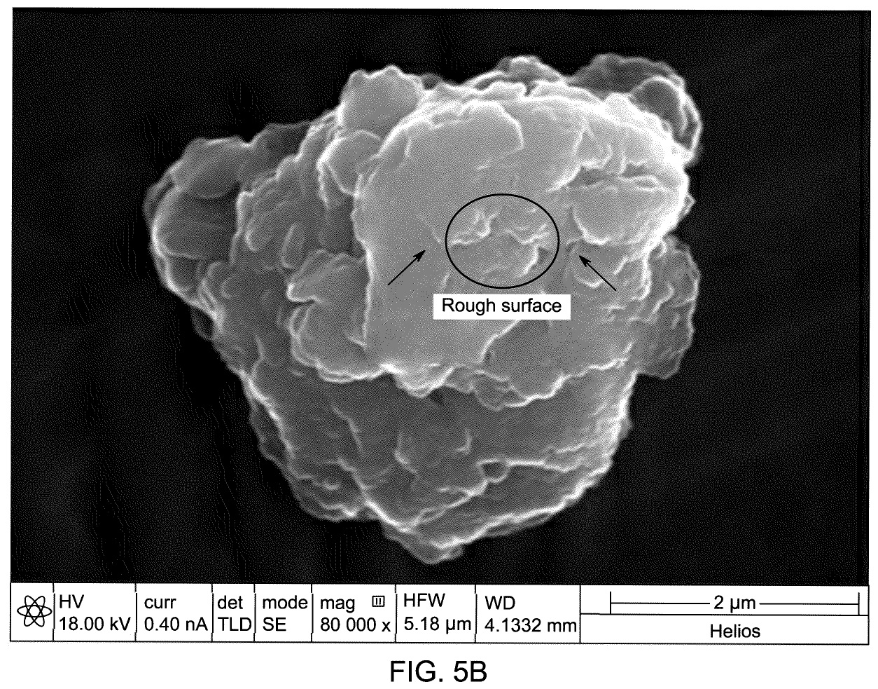

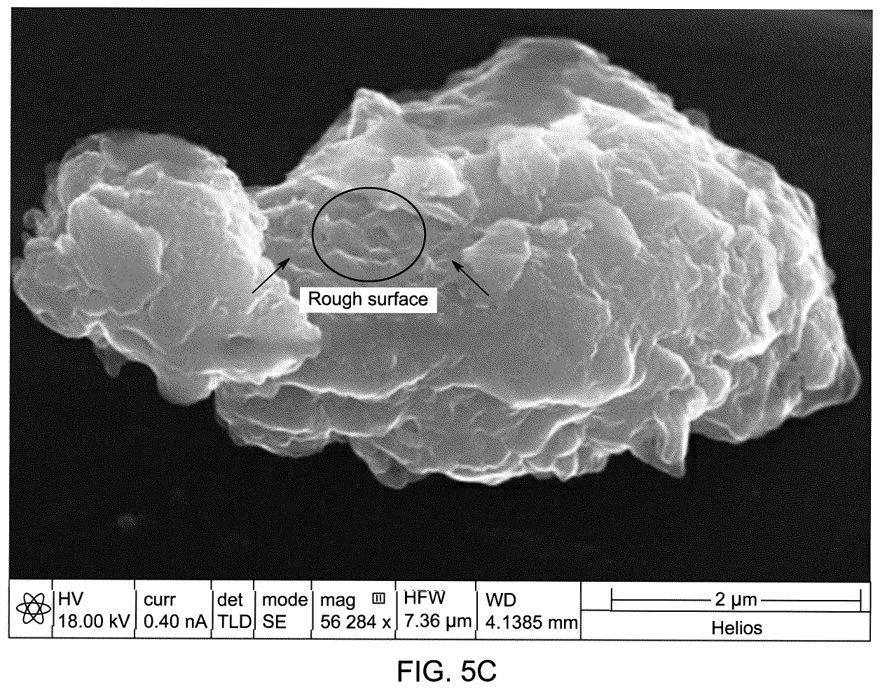

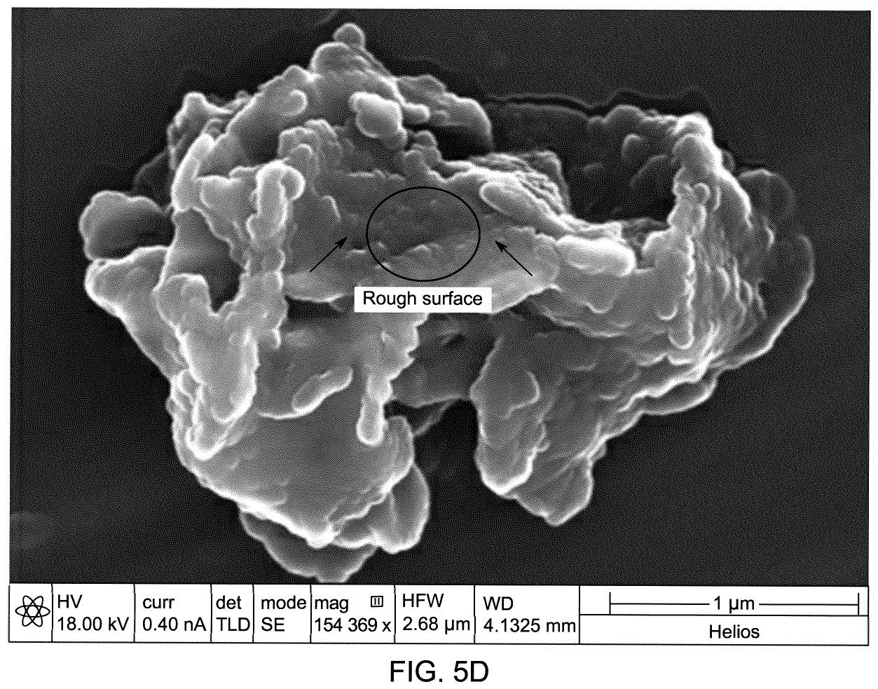

The surface roughness of clay samples was examined using the SEM technique. FIGS. 5A-5D display the SEM images of (FIG. 5A) AA-MMT, (FIG. 5B) TEPA10, (FIG. 5C) TEPA30, and (FIG. 5D) TEPA50 clay samples. The AA-MMT displayed a large surface area, layered structure, and smooth surface morphology with very slight particle aggregation. When AA-MMT clay was modified with TEPA (10 wt. %) functionality, there was no longer homogeneous and rough surface morphology. This is due to the development of interactions between amine functionalities and clay layers, making surfaces uneven/rough. The surface becomes rougher when the TEPA content increases from 10 to 50 wt. % (FIGS. 5B-5D). More functional groups result in better interactions, thus increasing surface roughness. The rough/uneven MMT surface is due to the formation of a thin layer of modifying agents. Thus, it is clear from these SEM results that the amine modification alters the surface morphology of MMT clay.

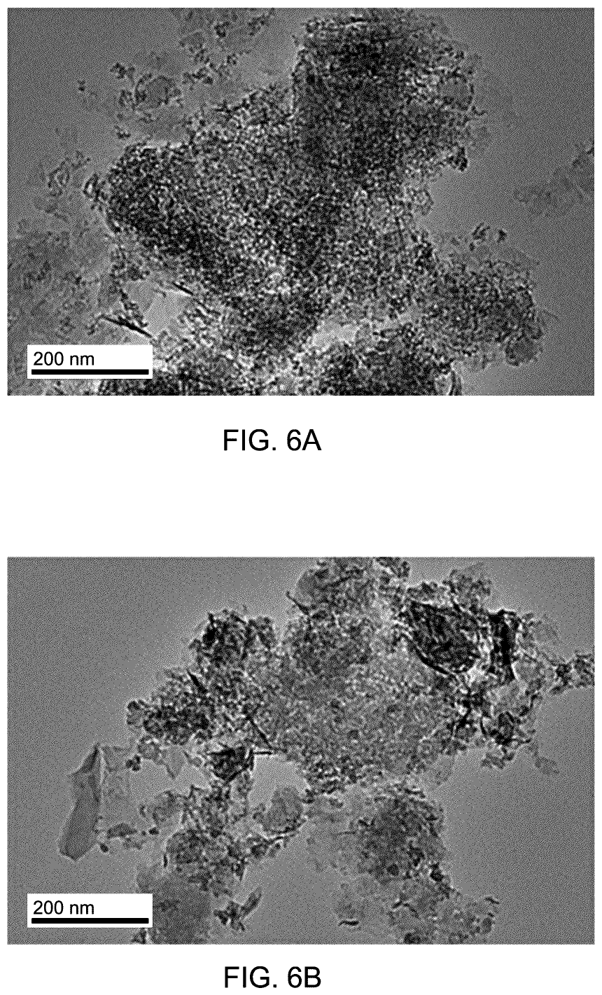

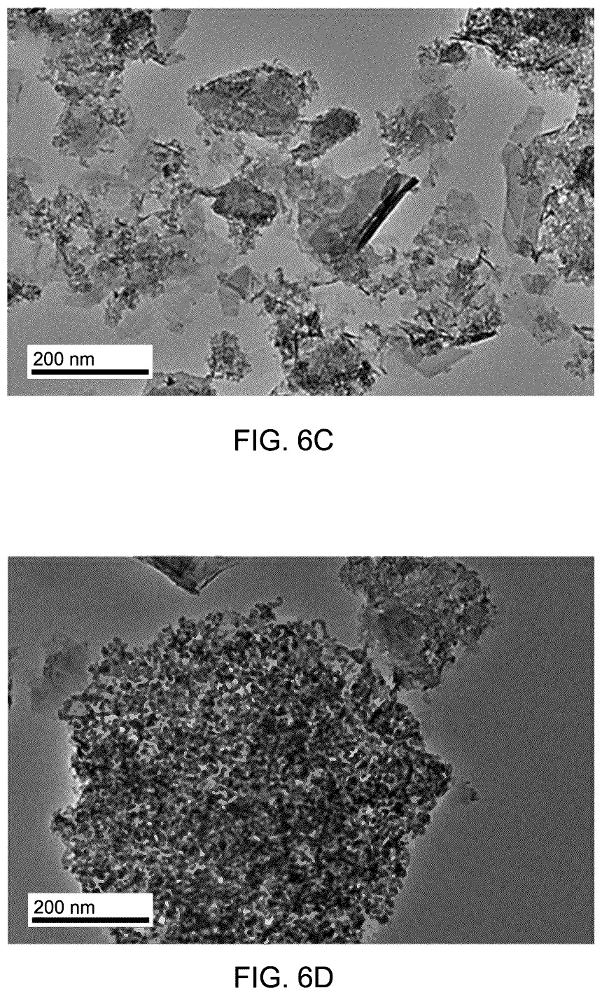

The porosity and internal structure of MMT clay samples were examined using the TEM technique. FIGS. 6A-6D shows TEM images of (FIG. 6A) AA-MMT, (FIG. 6B) TEPA10, (FIG. 6C) TEPA30, and (FIG. 6D) TEPA50 clay samples. It is clear from these TEM results that after acid treatment, the porosity and internal structure of MMT are retained; however, acidification results in a slight aggregation of clay particles. The TEPA modification results in an exfoliated MMT structure due to the intercalation of amines into clay galleries with the destruction of the MMT crystalline structure. The induction of amine functionalities into MMT galleries is confirmed by the appearance of small protrusions on the MMT surface, as shown in FIGS. 5B-5D. The arrangement of these small protrusions results in the development of a porous framework in the resultant material. In addition to amine functional groups, this porous structure also helps to adsorb CO₂ in the material. These interactions are also confirmed by FTIR and XRD results. After TEPA modification, —NH₂ covered the clay surface with this characteristic increased by raising TEPA percentage (10, 30, and 50 wt. %). The more covered MMT surface is obtained with TEPA30 and TEPA50 due to the presence of more functional groups. The materials with more active groups will adsorb greater CO₂ thus leading to an increased ability to enhance soil fertility and plant growth.

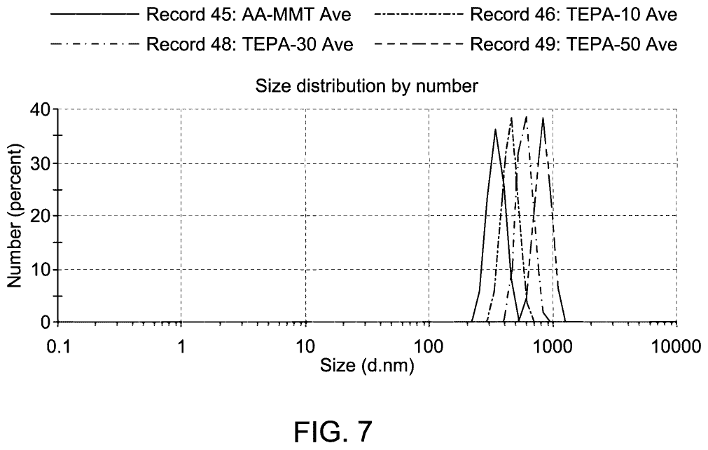

DLS technique was employed to measure the hydrodynamic size distribution of clay samples in a suspension by analyzing the fluctuation intensity of scattered light, providing the hydrodynamic size distribution of clay particles in terms of intensity, volume, or number. FIG. 7 displays the size distribution for AA-MMT, TEPA10, TEPA30, and TEPA50 clay samples. The average hydrodynamic size of the AA-MMT clay sample is 0.35 μm. The average hydrodynamic size of MMT clay was increased after TEPA modification. The hydrodynamic size of TEPA50 clay sample is still <1 μm (FIG. 7). The comparison indicates that TEPA-MMT clay samples are relatively monodispersed, and there is a uniform increase in the size distribution with increasing the concentration of TEPA ligand on MMT surface.

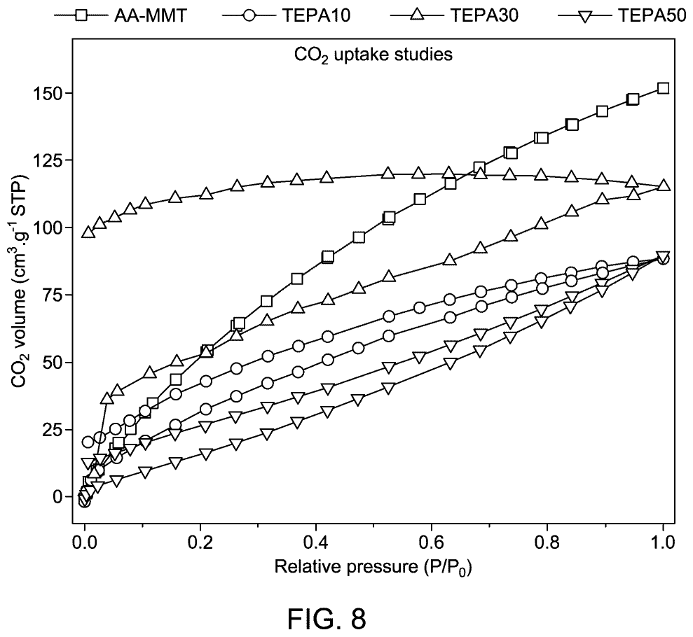

Carbon dioxide (CO₂) adsorption/desorption studies of porous materials, such as metal-organic frameworks (MOFs), zeolites, clays, and activated carbons, are crucial to assess their potential for carbon capture and storage applications. Herein, different percentages of TEPA moiety were inducted into AA-MMT clay galleries to analyze the impact of amine loading on the CO₂ adsorption capacity of resultant materials. The CO₂ adsorption experiments were conducted at 298 K using ultra-high pure CO₂ (99.99%) gas with a 20 mL/min flow rate. FIG. 8 demonstrates the CO₂ uptake results of pure AA-MMT clay and AA-MMT loaded with different percentages of TEPA (10, 30, and 50 wt. %) functionality. The CO₂ adsorption results showed that AA-MMT inducted with various amounts of TEPA showed different adsorption capacities. The CO₂ adsorption capacity of AA-MMT, TEPA10, TEPA30, and TEPA50 was 152.3, 88.6, 115.3, and 89.8 cm³ g⁻¹, respectively.

The CO₂ adsorption/desorption process in porous materials can occur via two primary mechanisms: physisorption and chemisorption. It can be seen that CO₂ uptake in the AA-MMT clay sample is physisorption, while CO₂ uptake in TEPA10, TEPA30, and TEPA50 clay samples is chemisorption. The physisorption mechanism involves the physical adsorption of CO₂ molecules (adsorbed substance) onto the surface of MMT clay (adsorbent). In this case, weak van der Waals forces (dispersion forces) are typically responsible for the interaction between CO₂ molecules and MMT's surface. Physisorption lacks specificity because the adsorbent in the given surface will interact with all present gases rather than just one gas. Physiosoprtion is reversible in nature due to the weak dispersion forces that cause the interaction of the CO₂ molecules and the surface of MMT. In chemisorption, adsorption takes place when an adsorbed substance is held to the adsorbent by chemical bonds, specifically covalent bonds. A chemically adsorbed substance is strongly bound to the adsorbent and cannot escape without the influx of a large amount of energy. This energy may be provided by heat and often high temperatures are required to clean an adsorbent of the chemically adsorbed substance. Chemisorption has high specificity and takes place only if there is a potential for chemical bonding between the adsorbent and the adsorbed substance. In this way, chemisorption is more specific because the adsorbent will only adsorb an adsorbed substance that is able to bond to its active surfaces. In AA-MMT, the amine groups on the clay's surface chemically react with CO₂ to form stable carbamate bonds (covalent bonds), allowing for high-capacity CO₂ capture. The comparison indicates that unmodified clay adsorbed high levels of CO₂ by physisorption due to the high surface area of pure MMT, whereas TEPA-modified MMT adsorbed the highest levels of CO₂ by chemisorption due to the availability of more active sites at the surface layer of AA-MMT without blocking the mesopores. Moreover, TEPA50 showed the least CO₂ uptake efficiency due to the high organic content of TEPA (50%), resulting in pore blocking of MMT.

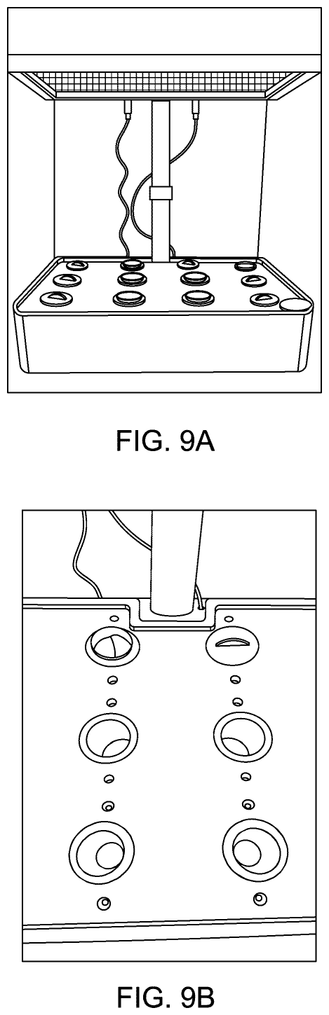

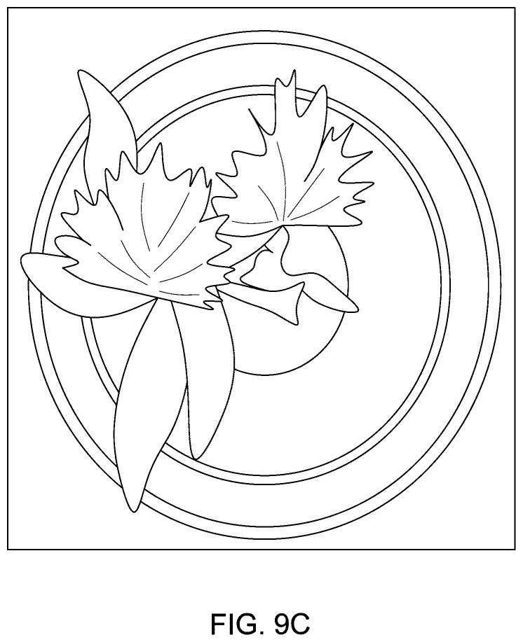

Several controlled plant growth trials were conducted using MMT clay-based adsorbent as a fertilizer. For this purpose, 10 g of each sample (sand, AA-MT, TEPA10, TEPA30, and TEPA50) was prepared by mixing pure sand and adsorbents in a ratio of 9:1 sand to adsorbents, as demonstrated in Table 1. The mint and coriander seeds were selected for this study and planted in a hydroponic setup to grow in a natural environment (FIGS. 9A-9C). Each seed was buried directly into the modified sand at a depth of about 0.5 to 1 cm in an individually labeled conical pot, and gently watered the sand at a rate of 2 mL/day for four weeks to ensure the seeds were in contact with moist sand. The seeds absorbed water and swelled, causing the seed coat to soften and trigger germination. Various parameters such as plant height, growth rate, and overall health of plants were assessed to evaluate the fertilizer's effectiveness. The results of this experiment indicate that the tiny soft stems (seed germination) appeared after one week of plantation. In the second week, round and thick seed leaves appeared, known as cotyledon. In third week, the seedling matured, and true leaves appeared on the plant's top. Finally, leaves expanded, stem strength increased, and new leaves emerged in the fourth week. The comparison indicates that the plants fertilized with TEPA30 showed a higher growth rate (height, biomass yield) than other prepared TEPA-based fertilizers. The TEPA30 sample showed the capability to retain and absorb increased amounts of water and CO₂ due to the presence of MMT clay and TEPA. The TEPA30 plant grew to a maximum height of 6.35 in the four weeks and was healthy at the end of the four weeks. The TEPA30 plant experienced 9% greater growth, preferably 11% greater, preferably 13% greater, preferably 15% greater, preferably 18% greater, preferably 21% greater, preferably 23% greater, preferably 25% greater, preferably 28% greater, preferably 31% greater, preferably 33% greater, preferably 35% greater, preferably 38% greater, preferably 41% greater, preferably 43% greater, preferably 45% greater, preferably 48% greater, preferably 51% greater, preferably 53% greater, preferably 55% greater, most preferably 55.28% greater growth as compared to the other samples. The enhancement of plant growth with TEPA30 is associated with increased amino functional groups/adsorption sites at the AA-MMT surface, which adsorbed increased amounts of CO₂ compared to other prepared fertilizers having different TEPA percentages. The fertilizer with a higher CO₂ adsorption rate improved soil fertility with better plant growth. These results agree with CO₂ adsorption results.

TABLE 1

| | Amount | Sample:sand | Total | Max plant | |
|---|---|---|---|---|---|
| | of | ratio | amount | height | Plant |
| Sample | TEPA | (g:g) | (g) | (cm) | Health |
| Control | 0% | 00:10 | 10 | 3.60 | Died |
| AA-MMT | 0% | 01:09 | 10 | 4.80 | Very weak |
| TEPA10 | 10% | 01:09 | 10 | 5.08 | Weak |
| TEPA30 | 30% | 01:09 | 10 | 6.35 | Healthy |
| TEPA50 | 50% | 01:09 | 10 | 3.05 | Unhealthy, |
| | | | | | died |

Additionally, the MMT clay has a large surface area and porous morphology, which retains more water molecules available for plants. Hence, the use of MMT is also favorable for enhanced plant growth. Moreover, the amine modification further enhances MMT properties for plant growth. The AA-MMT modified with a moderate amount of TEPA improved CO₂ adsorption capacity on MMT's surface, which ultimately increased soil fertility and enhanced plant growth.

To conclude, aspects of the present disclosure are directed to mitigating carbon dioxide (CO₂) emissions in the atmosphere by storing it in sandy soil and utilizing it for plant growth. MMT clay was successfully purified and acidified with HCl to increase its surface area and porosity. The MMT clay was functionalized with TEPA as an effective CO₂ adsorbent to enhance soil fertility. Pure MMT, acidified MMT, and TEPA-modified MMT clay samples were successfully characterized by XRD, FTIR, SEM, TEM, and DLS techniques. The results indicate that the clay structure is retained, TEPA moiety is present, and the surface roughness is increased after TEPA modification. CO₂ adsorption results suggest that TEPA30 is the most suitable clay sample with a higher plant growth rate than other prepared TEPA-based fertilizers.

Numerous modifications and variations of the present disclosure are possible in light of the above teachings. It is, therefore, to be understood that within the scope of the appended claims, the invention may be practiced otherwise than as specifically described herein.

1. A method of amending a soil, comprising:
treating a montmorillonite (MMT) clay with an inorganic acid to form a treated clay having greater surface area and porosity than the MMT;
mixing tetraethylenepentamine (TEPA) with the treated clay to form a soil amendment comprising the TEPA in an amount of 10 to 50 wt. % based on the weight of the soil amendment;
mixing the soil amendment with the soil to form a plant growth substrate;
chemisorbing CO₂ onto the soil amendment of the plant growth substrate;
wherein the plant growth substrate is capable of improved plant growth rate in comparison to the soil without the soil amendment, and
wherein the soil with the soil amendment has a plant growth rate at least 9% greater than the plant growth rate of the soil in the absence of the soil amendment.

2. The method of claim 1, wherein the soil amendment is in the form of a fine powder having a particle size of less than 0.6 mm.

3. The method of claim 1, wherein the inorganic acid is selected from the group consisting of hydrochloric acid (HCl), sulfuric acid (H₂SO₄), perchloric acid (HCIO₄), boric acid (H₃BO₃), and nitric acid (HNO₃).

4. The method of claim 1, wherein the inorganic acid is HCl.

5. The method of claim 2, wherein the particles of the fine powder have a rough surface with a plurality of protrusions having a diameter of 0.5 μm or less.

6. The method of claim 2, wherein the soil amendment has an average hydrodynamic size of 0.15 to 2.5 μm.

7. The method of claim 1, wherein the soil amendment is amorphous.

8. The method of claim 1, wherein the plant growth substrate has a mass ratio of sand to soil amendment of 1:1 to 10:1.

9. The method of claim 1, wherein the soil is at least one selected from the group consisting of pure sand, sandy soil, clay soil, silt soil, peat soil, and loam soil.

10. The method of claim 1, wherein the soil is sandy soil.

11. The method of claim 1, wherein the plant growth substrate has a pH of 3 to 8.

12. The method of claim 2, wherein the soil amendment has an average surface area of 10 to 400 m²/g.

13. The method of claim 2, wherein the soil amendment has an average pore diameter no more than 8 cm³/g.

14. The method of claim 2, wherein the soil amendment has an average pore volume of 0.01 to 0.6 cm³/g.

15. The method of claim 1, wherein the TEPA is present in an amount of 30 wt. %,

16. The method of claim 1, wherein the plant growth substrate is in the form of a micropellet having an average diameter of 0.1 to 3 mm.

17. The method of claim 1, wherein the plant growth substrate further comprises:
at least one selected from the group consisting of nitrogen (N), potassium (K), phosphorus (P), calcium (Ca), magnesium (Mg), sulfur(S), boron (B), copper (Cu), iron (Fe), manganese (Mg), zinc (Zn), chlorine (Cl), and cobalt (Co); and
a humate comprising at least one selected from the group consisting of humic acid, fulvic acid, humin, and hymatomelanic acid.

18. The method of claim 1, wherein the soil amendment has a CO₂ adsorption capacity of 70 to 130 cm³/g.

19. The method of claim 1, wherein the soil amendment has a CO₂ adsorption capacity of 115.3 cm³/g.

20. The method of claim 1, wherein the plant growth substrate has a ratio of sand to soil amendment of 9:1.
